(19) United States
(12) Patent Application Publication
(10) Pub. No.: US 2023/0318110 A1
(43) Pub. Date: Oct. 5, 2023

(54) BATTERY UNIT

(71) Applicant: HONDA MOTOR CO., LTD., Tokyo (JP)

(72) Inventors: Ryo SHINODA, Tokyo (JP); Tetsuya SUGIZAKI, Tokyo (JP); Hiroki SAKAMOTO, Tokyo (JP); Jaewon SON, Tokyo (JP); Ryuta NISHIGAMI, Tokyo (JP); Yuki KAGAWA, Osaka (JP)

(73) Assignee: HONDA MOTOR CO., LTD., Tokyo (JP)

(21) Appl. No.: 18/127,370

(22) Filed: Mar. 28, 2023

(30) Foreign Application Priority Data
Mar. 30, 2022 (JP) 2022-057579

(51) Int. Cl. H01M 50/249; H01M 50/209; H01M 10/6563; H01M 10/625; B60K 1/04

(52) U.S. Cl. CPC H01M 50/249; H01M 50/209; H01M 10/6563; H01M 10/625; B60K 1/04; H01M 2220/20; B60K 2001/005

(57) ABSTRACT

A battery unit mounted on a vehicle includes a base plate, and a battery module which is fixed to the base plate and in which a plurality of battery cells are stacked. A flow path is formed between the base plate and the battery module. The base plate is provided with a first suspension member which crosses the flow path and forms a part of the flow path, and a second suspension member which extends above the first suspension member.

### CROSS-REFERENCE TO RELATED APPLICATIONS

This application is based on and claims priority under 35 USC 119 from Japanese Patent Application No. 2022-057579 filed on Mar. 30, 2022.

### TECHNICAL FIELD

The present disclosure relates to a battery unit mounted on an electric vehicle or the like.

### BACKGROUND ART

In recent years, researches and development on secondary batteries which contribute to improvement in efficiency of energy have been carried out to secure an access to affordable, reliable, sustainable, and modern energy for more people.

The secondary battery is mounted as a battery unit on an electric vehicle such as an electric automobile or a hybrid electric automobile. In general, a battery unit is unitized together with a fan for blowing cooling air to a battery, a duct for guiding the cooling air blown out from the fan to the battery, and the like (for example, see JP-A-2020-032934).

When the battery unit is mounted on the electric vehicle, the battery unit needs to have sufficient rigidity in order to protect internal components from a collision of the vehicle or the like. In addition, in order to facilitate assembly of components, it is also required to reduce the number of components.

### SUMMARY

The present disclosure provides a battery unit in which rigidity of a base plate can be improved with a small number of components. Further, the present disclosure contributes to improvement in efficiency of energy.

According to an aspect of the present disclosure, there is provided a battery unit mounted on a vehicle, the battery unit including: a base plate; and a battery module which is fixed to the base plate and in which a plurality of battery cells are stacked, in which: a flow path is formed between the base plate and the battery module; and the base plate is provided with: a first suspension member which crosses the flow path and forms a part of the flow path; and a second suspension member which extends above the first suspension member.

According to the present disclosure, the rigidity of the base plate can be improved with a small number of components.

### BRIEF DESCRIPTION OF DRAWINGS

FIG. 1 is a perspective view of a periphery of a rear seat of a vehicle V on which a battery unit 10 according to an embodiment of the present disclosure is mounted.

FIG. 2 is an exploded perspective view of the battery unit 10 according to the embodiment of the present disclosure.

FIG. 3 is a perspective view of a base plate 50 to which a lower suspension member 81 and an upper suspension member 82 are attached.

FIG. 4 is a partial perspective view of the base plate 50 on which a fan 20, an air feeding duct 40, and a battery module 11 are mounted.

FIG. 5 is a top view of the base plate 50 in FIG. 4 at the time when the battery module 11 is not mounted.

FIG. 6 is a cross-sectional view taken along a line A-A in FIG. 5.

FIG. 7 is a perspective view of the air feeding duct 40 as viewed from the lower left.

### DESCRIPTION OF EMBODIMENTS

Hereinafter, an embodiment of a battery unit of the present disclosure will be described with reference to accompanying drawings. In the present embodiment, the battery unit is mounted on a vehicle. Note that the drawings are to be viewed according to orientation of the reference signs. In the present specification and the like, in order to simplify and clarify the description, a front-rear direction, a left-right direction, and an up-down direction are described in accordance with directions viewed from a driver of the vehicle. In the drawings, a front side of the vehicle is denoted by Fr, a rear side thereof is denoted by Rr, a left side thereof is denoted by L, a right side thereof is denoted by R, an upper side thereof is denoted by U, and a lower side thereof is denoted by D.

<Vehicle>

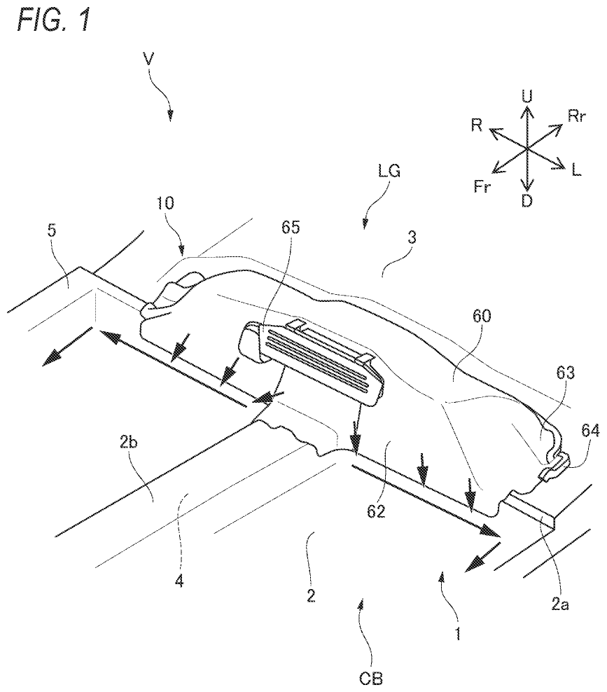

As illustrated in FIG. 1, a battery unit 10 of the present embodiment is mounted on a vehicle V. The vehicle V is an electric vehicle such as a hybrid vehicle or an electrical vehicle, and is configured to be able to travel by driving a motor with electric power stored in the battery unit 10. The battery unit 10 is mounted on a floor panel 1 and fixed to the floor panel 1. A rear seat of the vehicle V is disposed above the battery unit 10.

The floor panel 1 includes a front floor panel 2 which constitutes a floor of a vehicle cabin CB, and a rear floor panel 3 which constitutes a floor or the like of a luggage compartment LG provided behind the vehicle cabin CB. The front floor panel 2 and the rear floor panel 3 are connected below the rear seat. Both ends of the floor panel 1 in a vehicle width direction are connected to a pair of left and right frame members 5 extending along the front-rear direction, whereby the floor panel 1 is fixed to the frame members 5.

A kick-up portion 2a which rises upward is formed at a rear end of the front floor panel 2. A center tunnel 2b is formed along the front-rear direction at a center portion of the front floor panel portion 2 in the vehicle width direction. The center tunnel 2b is bent such that the front floor panel 2 protrudes upward, and a trapezoidal tunnel space 4 is formed below the center tunnel 2b.

<Overall Configuration of Battery Unit>

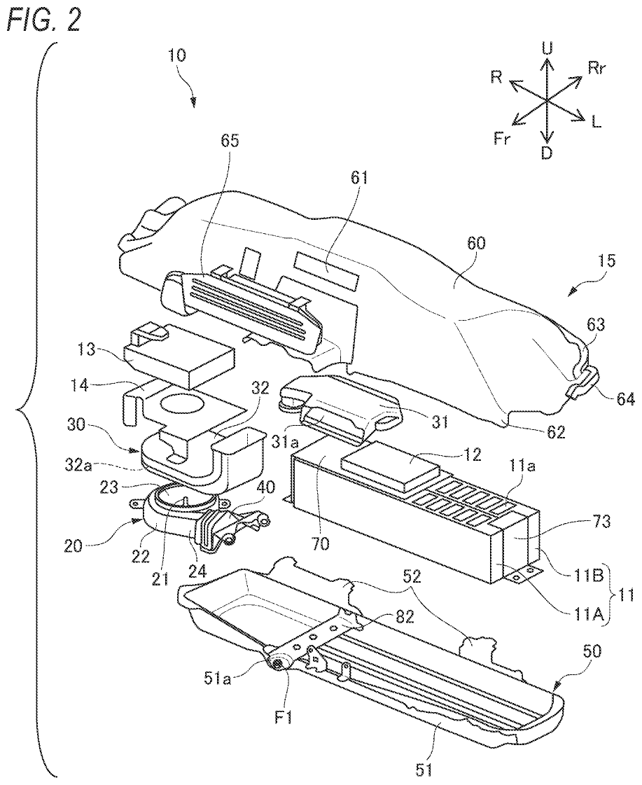

As illustrated in FIG. 2, the battery unit 10 includes a battery module 11, a fan 20 which blows out a cooling gas for cooling the battery module 11, an intake duct 30 through which the cooling gas is introduced into the fan 20, an air feeding duct 40 through which the cooling gas blown out from the fan 20 is sent out in a desired direction, a battery control device 12 which controls charging and discharging of the battery module 11, a junction board 13 which electrically connects the battery module 11 and an external device (not illustrated) and on which wiring components, through which charging electric power and discharging electric power of the battery module 11 flow, are mounted, and a case 15 which accommodates these members. The fan 20, the intake duct 30, the air feeding duct 40, the battery control device 12, and the junction board 13 are provided at a position where at least a part thereof overlaps the battery module 11 as viewed in the vehicle width direction.

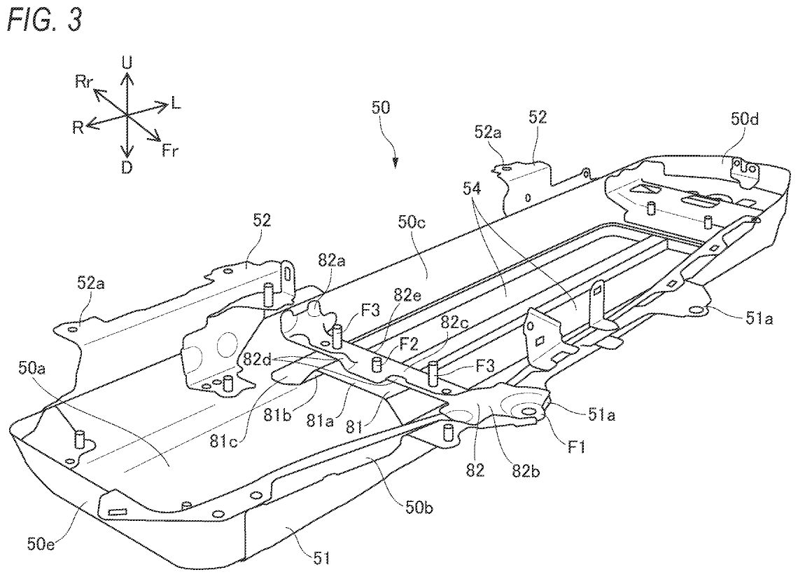

The case 15 includes a base plate 50 on which the battery module 11, the fan 20, and the air feeding duct 40 are mounted, and a cover 60 which covers the base plate 50 from above. An accommodating recess (not illustrated) extending in the vehicle width direction is provided in a front end of the rear floor panel 3 illustrated in FIG. 1, and the base plate 50 is accommodated in the accommodating recess. The cover 60 covers the base plate 50 and is fixed to the floor panel 1. An intake port 61 is formed in a front surface of the cover 60, and the intake port 61 is covered with a grille 65 through which air can pass. Details of the base plate 50 will be described later with reference to FIG. 3.

The battery module 11 includes a front battery module 11A disposed at a front side and a rear battery module 11B disposed at a rear side. The battery modules 11A and 11B each have a substantially rectangular parallelepiped shape elongated in the vehicle width direction, and are mounted on the base plate 50 so as to face each other in the front-rear direction. Hereinafter, when the front battery module 11A and the rear battery module 11B are not distinguished from each other, the front battery module 11A and the rear battery module 11B are collectively referred to as the battery module 11.

The battery module 11 includes a plurality of battery cells stacked in the vehicle width direction. An inter-cell flow path 11a is formed between adjacent battery cells, and the cooling gas flows through the inter-cell flow path 11a to cool the battery module 11.

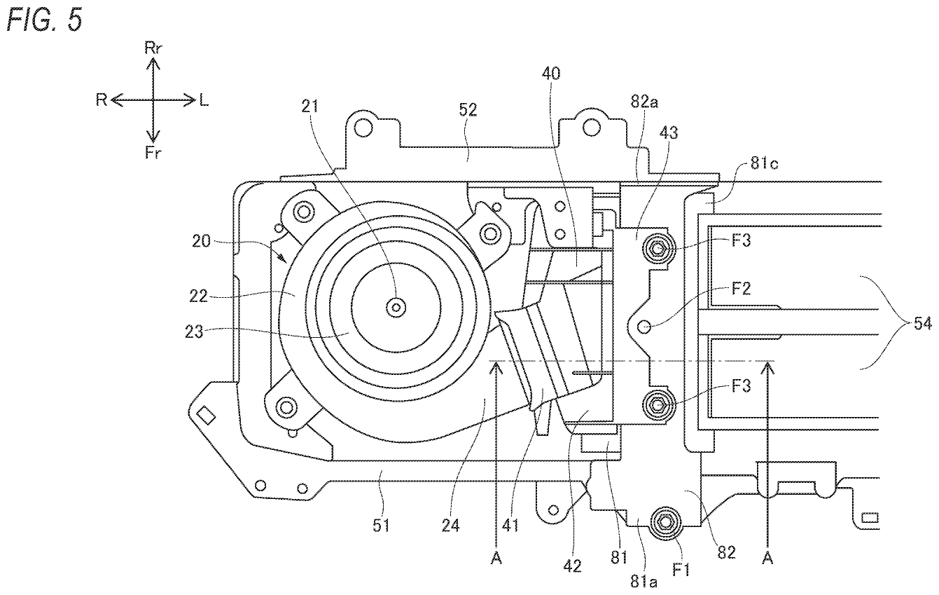

The fan 20 is fixed to the base plate 50. As illustrated in FIGS. 2, 4, and 5, the fan 20 includes an impeller 21 which takes in the cooling gas from a rotation axis direction and blows out the cooling gas in a centrifugal direction, and a fan case 22 which pivotally supports the impeller 21 and accommodates the impeller 21. The fan case 22 includes a suction port 23 through which the cooling gas supplied to the impeller 21 is sucked in, and an air blow-out port 24 through which the cooling gas blown out from the impeller 21 is discharged. In the present embodiment, a rotation axis of the impeller 21 extends in the up-down direction. The fan case 22 has a substantially columnar shape extending in the up-down direction. The suction port 23 is open to the upper side. The air blow-out port 24 protrudes leftward from the substantially columnar fan case 22 and is open to the left side. Therefore, the fan 20 sucks the cooling gas above from the suction port 23 and sends out the cooling gas leftward from the air blow-out port 24.

As illustrated in FIG. 2, the intake duct 30 connects the intake port 61 of the cover 60 and the suction port 23 of the fan 20, and guides air in the vehicle cabin CB as the cooling gas from the intake port 61 to the fan 20. The intake duct 30 includes an upstream intake duct 31 disposed above the battery module 11 and a downstream intake duct 32 disposed at the right side of the battery module 11. The upstream intake duct 31 has an intake port connection portion 31a connected to the intake port 61, and the downstream intake duct 32 has a fan connection portion 32a connected to the suction port 23. The upstream intake duct 31 and the downstream intake duct 32 are connected to each other, and flow paths thereof communicate with each other.

The air feeding duct 40 is provided between the battery module 11 and the fan 20, and is connected to the air blow-out port 24 of the fan 20. The cooling gas blown out from the air blow-out port 24 is sent out through the air feeding duct 40 along a lower surface of the battery module 11. Details of the air feeding duct 40 will be described later.

The cooling gas sent out to a lower side of the battery module 11 flows from a lower side to an upper side in the inter-cell flow path 11a, cools the battery module 11, and is discharged from an upper surface of the battery module 11. Thereafter, the cooling gas flows inside the case 15 toward a gap formed between a front end 62 of the cover 60 and the floor panel 1, and is discharged to the outside of the case 15 as indicated by arrows in FIG. 1. A seal member 64 is provided at a gap formed between a rear end 63 of the cover 60 and the floor panel 1, and is configured such that the cooling gas is not discharged to a rear floor panel 3 side. The seal member 64 is made of, for example, an elastic material such as rubber.

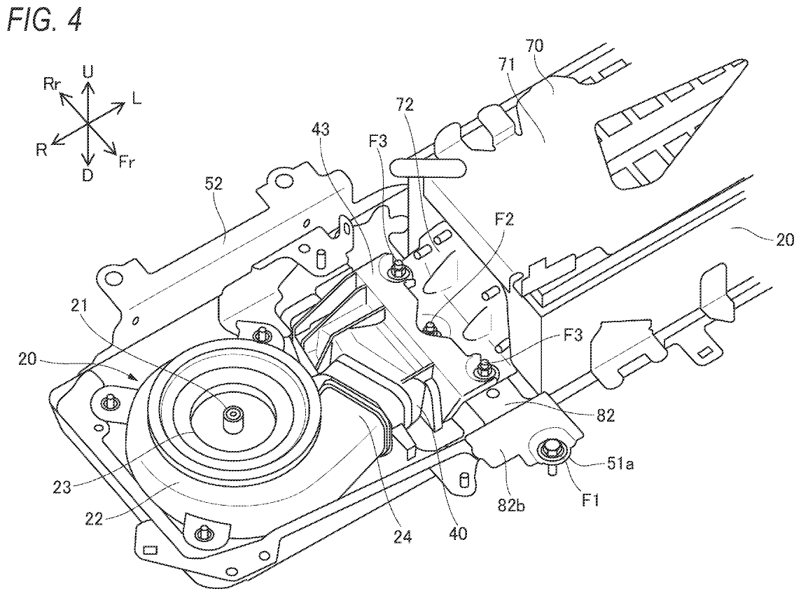

The battery control device 12 is disposed between the upstream intake duct 31 and the battery module 11. An L-shaped bracket 70 is fixed to the battery module 11, and the bracket 70 has a control device fixing portion 71 facing the upper surface of the battery module 11 and a module fixing portion 72 facing a right surface of the battery module 11 (see FIG. 4). The battery control device 12 is mounted on the control device fixing portion 71. The battery control device 12 is implemented by an electronic control unit (EC U) including a processor, a memory, an interface, and the like.

The junction board 13 is disposed above the downstream intake duct 32. More specifically, the junction board 13 is mounted on a junction board bracket 14 provided above the downstream intake duct 32. The junction board bracket 14 is fixed to the base plate 50.

<Structure of Base Plate>

Next, a structure of the base plate 50 and a flow path 53 formed in the base plate 50 will be described with reference to FIGS. 3 to 7.

As illustrated in FIG. 3, the base plate 50 includes a bottom wall 50a which covers the battery module 11 and the fan 20 from below, a front wall 50b which is bent upward from a front edge of the bottom wall 50a, a rear wall 50c which is bent upward from a rear edge of the bottom wall 50a, a left wall 50d which is bent upward from a left edge of the bottom wall 50a, and a right wall 50e which is bent upward from a right edge of the bottom wall 50a.

The base plate 50 includes a front frame 51 provided at the front wall 50b and a rear frame 52 provided at the rear wall 50c. The front frame 51 has a vehicle fixing portion 51a fixed to the kick-up portion 2a of the front floor panel 2, and the rear frame 52 has a vehicle fixing portion 52a fixed to the front end of the rear floor panel 3. Specifically, the vehicle fixing portion 51a and the vehicle fixing portion 52a are through holes, and the base plate 50 is fixed to the floor panel 1 of the vehicle V by fastening members such as bolts inserted through the through holes. The vehicle fixing portion 51a and the vehicle fixing portion 52a may be directly provided in the base plate 50 without providing the front frame 51 and the rear frame 52.

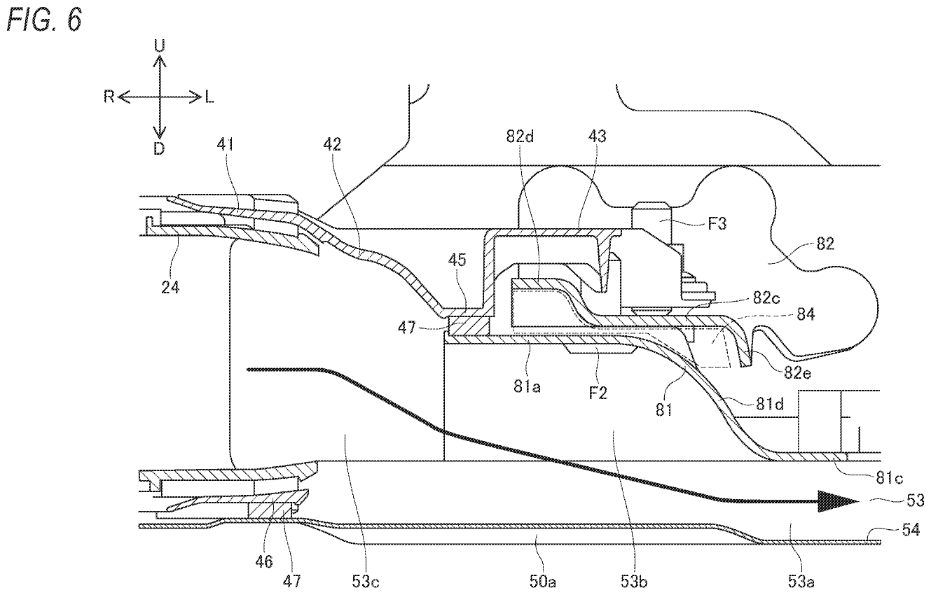

As illustrated in FIG. 6, the flow path 53 extending from the air blow-out port 24 of the fan 20 to a space between the bottom wall 50a and the lower surface of the battery module 11 is formed in the base plate 50. The flow path 53 includes a flow path 53a formed by the lower surface of the battery module 11 and the bottom wall 50a, a flow path 53b formed by a lower surface of a lower suspension member 81 described later and the bottom wall 50a, and a flow path 53c formed by an inner surface of the air feeding duct 40 and the bottom wall 50a.

Returning to FIG. 3, a recess 54 extending in the vehicle width direction (longitudinal direction) is formed in the bottom wall 50a of the base plate 50 at a position where the battery module 11 is mounted. Two recesses 54 are formed correspondingly to positions of the battery modules 11A and 11B. The flow path 53a is formed in a space defined by the recess 54 and the lower surface of the battery module 11.

The base plate 50 is provided with the lower suspension member 81 which crosses the flow path 53 in the front-rear direction and which forms a part of the flow path 53 (that is, the flow path 53b). The lower suspension member 81 is a plate-like member fixed to the bottom wall 50a. The lower suspension member 81 is disposed between the battery module 11 and the air feeding duct 40 in a direction in which the flow path 53 extends (that is, the vehicle width direction).

As illustrated in FIGS. 3 and 6, the lower suspension member 81 includes a ceiling portion 81a extending in the front-rear direction, and leg portions 81b extending obliquely downward from a front edge and a rear edge of the ceiling portion 81a. A flange portion 81c is provided at a tip end of the leg portion 81b, and is fixed to the bottom wall 50a of the base plate 50. In addition, a side wall 81d inclined downward is provided at a left end of the ceiling portion 81a. The flange portion 81c is also provided at a tip end of the side wall 81d.

The flow path 53b is formed in a space defined by the lower surface of the lower suspension member 81 and the bottom wall 50a of the base plate 50, and communicates with the flow path 53a. Therefore, the lower suspension member 81 functions as a duct which forms a part of the flow path 53. Further, since the lower suspension member 81 extends in the front-rear direction and is fixed to the base plate 50, the rigidity of the base plate 50 can be improved. Therefore, the lower suspension member 81 also functions as a reinforcing member which reinforces the base plate 50. Therefore, by using the lower suspension member 81 functioning as a duct also as a reinforcing member, the rigidity of the base plate 50 can be improved with a small number of components.

The base plate 50 is provided with an upper suspension member 82 extending in the front-rear direction above the lower suspension member 81. The upper suspension member 82 is a plate-like member similar to the lower suspension member 81, and is disposed between the battery module 11 and the air feeding duct 40 in the direction in which the flow path 53 extends. A rear end 82a of the upper suspension member 82 is fixed to the rear wall 50c of the base plate 50 by welding or the like, and a front end 82b of the upper suspension member 82 is fixed to the vehicle fixing portion 51a of the front frame 51 at a front end fixing portion F1. The front end fixing portion F1 is a through hole, and is fixed to the vehicle fixing portion 51a by a fastening member such as a bolt.

In this way, since the upper suspension member 82 extends in the front-rear direction and is fixed to the base plate 50, it is possible to further improve the rigidity of the base plate 50 together with the lower suspension member 81. In particular, since the upper suspension member 82 has the front end fixing portion F1 fixed to the vehicle fixing portion 51a, the rigidity of the vehicle fixing portion 51a can also be improved.

The upper suspension member 82 has a fixing portion F2 fixed to the ceiling portion 81a of the lower suspension member 81. The fixing portion F2 is a through hole. At the fixing portion F2, a bolt is inserted into through holes which are formed in the ceiling portion 81a of the lower suspension member 81 and the upper suspension member 82 to communicate with each other, and is fastened by a nut. Accordingly, the upper suspension member 82 and the lower suspension member 81 are fixed to each other, and function as a stronger reinforcing member. As will be described later, the module fixing portion 72 of the bracket 70 may be fixed with the fixing portion F2.

As illustrated in FIGS. 3 and 6, the upper suspension member 82 includes a contact portion 82c which comes into contact with the ceiling portion 81a of the lower suspension member 81, step portions 82d formed at a right front edge and a right rear edge, and a bent portion 82e formed at a left edge. The step portion 82d has a step shape protruding upward from the contact portion 82c, and is separated from the ceiling portion 81a of the lower suspension member 81. The bent portion 82e is bent downward, and is separated from the ceiling portion 81a and the side wall 81d of the lower suspension member 81. With such a configuration, a space 84 is defined between the lower suspension member 81 and the upper suspension member 82 in a cross section orthogonal to a direction (front-rear direction) in which the lower suspension member 81 and the upper suspension member 82 extend. Therefore, a structure which reinforces the base plate 50 more firmly is formed, and the rigidity of the base plate 50 can be improved.

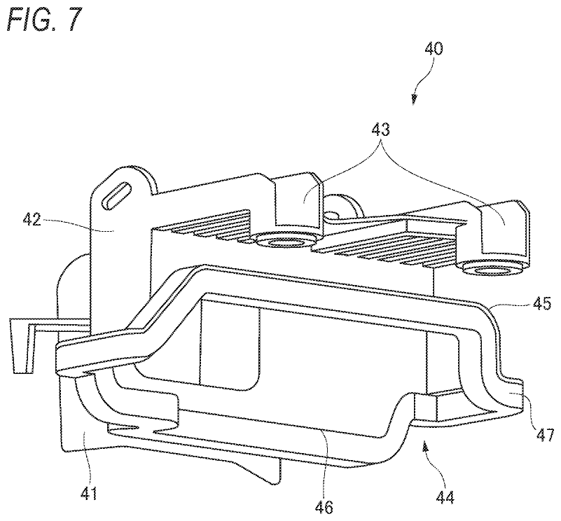

The air feeding duct 40 connects the air blow-out port 24 of the fan 20 and the lower suspension member 81, and forms the flow path 53c communicating with the flow path 53b. As illustrated in FIG. 7, the air feeding duct 40 includes a connecting portion 41 which connects to the air blow-out port 24 of the fan 20, and a main body portion 42 in which an opening 44 which is open to the lower side and the left side is formed. The flow path 53c is formed between an inner surface of the main body portion 42 and the bottom wall 50a of the base plate 50.

An outer edge (a part of the inner surface of the air feeding duct 40) of the opening 44 includes a left edge 45 facing an upper surface (upper surfaces of the ceiling portion 81a, the leg portion 81b, and the flange portion 81c) of the lower suspension member 81, and a right edge 46 continuous with the left edge 45 and facing the bottom wall 50a of the base plate 50. The left edge 45 has a shape corresponding to the upper surface of the lower suspension member 81, and the right edge 46 has a shape corresponding to the bottom wall 50a.

A seal member 47 is continuously provided at the left edge 45 and the right edge 46 of the air feeding duct 40. The seal member 47 is made of, for example, an elastic material such as rubber. When the air feeding duct 40 is attached to the base plate 50, the seal member 47 is disposed between the left edge 45 and the upper surface of the lower suspension member 81, and seals the flow path 53 so that the cooling gas does not leak from the flow path 53. Similarly, the seal member 47 is disposed between the right edge 46 and the bottom wall 50a of the base plate 50, and seals the flow path 53 so that the cooling gas does not leak from the flow path 53. Therefore, the flow path 53 can be sealed only by covering the upper surface of the lower suspension member 81 with the air feeding duct 40 from above. Therefore, assembly of the battery unit 10 is facilitated.

Next, fixing of the battery module 11 and the air feeding duct 40 to the upper suspension member 82 will be described.

The module fixing portion 72 of the bracket 70 is fixed to the right surface of the battery module 11. The module fixing portion 72 is fixed to the upper surface of the upper suspension member 82 as described later. That is, the battery module 11 is fixed to the base plate 50 via the module fixing portion 72 and the upper suspension member 82.

The upper suspension member 82 includes fixing portions F3 by which the module fixing portion 72 is fixed. The fixing portions F3 are provided at two positions spaced apart from each other in the front-rear direction, and the fixing portion F2 is disposed between the two fixing portions F3. The fixing portion F3 is a through hole. At the fixing portion F3, a bolt is inserted into through holes which are formed in a lower end of the module fixing portion 72 and the upper suspension member 82 so as to communicate with each other, and is fastened by a nut. Accordingly, the module fixing portion 72 is fixed to the upper suspension member 82. Therefore, the upper suspension member 82 can also support the battery module 11 while functioning as a reinforcing member which reinforces the base plate 50.

The module fixing portion 72 is also fixed by the fixing portion F2 by which the upper suspension member 82 and the lower suspension member 81 are fixed. Specifically, a bolt which fastens the lower suspension member 81 and the upper suspension member 82 is also inserted into the through hole formed in the lower end of the module fixing portion 72, and is fastened by a nut. As described, since the module fixing portion 72 is fixed to both the lower suspension member 81 and the upper suspension member 82 by the fixing portion F2, the rigidity of the structure for fixing the battery module 11 can be improved as compared with a case where the module fixing portion 72 is fixed only to the upper suspension member 82.

As illustrated in FIG. 2, a bracket 73 for fixing the battery module 11 is separately provided at a left surface of the battery module 11, and is fixed to the base plate 50.

After the upper surface of the lower suspension member 81 is covered with the air feeding duct 40 from above, the air feeding duct 40 is fixed to the upper suspension member 82 by the fixing portions F3. That is, the upper suspension member 82 is also used for fixing the air feeding duct 40.

Specifically, the air feeding duct 40 includes an extension portion 43 which extends in a horizontal direction from an upper end of the main body portion 42. The extension portion 43 extends to above the module fixing portion 72 and the upper suspension member 82. At the fixing portion F3, the bolt inserted through the through holes formed in the upper suspension member 82 and the module fixing portion 72 is also inserted through a through hole formed in the extension portion 43, and is fastened by a nut.

In this way, the air feeding duct 40 is disposed on the base plate 50 so as to cover the upper surface of the lower suspension member 81 from above, and is fixed to the upper suspension member 82 by the fixing portion F3. Therefore, assembly of the air feeding duct 40 is facilitated. In addition, since the fixing portion F3 fixes both the air feeding duct 40 and the module fixing portion 72 to the upper suspension member 82, the number of components can be reduced as compared with a case where the fixing portion is provided for each of the air feeding duct 40 and the module fixing portion 72. The air feeding duct 40 may be fixed to the upper suspension member 82 by another fixing portion different from the fixing portion F3.

Although one embodiment of the present invention has been described above with reference to the accompanying drawings, it is needless to say that the present invention is not limited to the embodiment. It is apparent that those skilled in the art can conceive various modifications and alterations within the scope described in the claims, and it is also understood that such modifications and alterations naturally fall within the technical scope of the present invention. Further, the constituent elements in the embodiments described above may be combined freely within a range not departing from the gist of the invention.

For example, in the above-described embodiment, the fixing by the front end fixing portion F1 and the fixing portions F2 and F3 of the upper suspension member 82 is implemented with a configuration of fastening by inserting a bolt or the like through a through hole, but is not limited thereto. For example, the fixing by the front end fixing portion F1 and the fixing portions F2 and F3 may be implemented with a configuration in which the upper suspension member 82 and another member are fixed by welding or the like.

At least the following matters are described in the present description. Although corresponding constituent elements and the like in the above embodiment are shown in parentheses, the present invention is not limited thereto.

(1) A battery unit (battery unit 10) mounted on a vehicle, the battery unit including:
a base plate (base plate 50); and
a battery module (battery module 11) which is fixed to the base plate and in which a
plurality of battery cells are stacked, in which:
a flow path (flow path 53) is formed between the base plate and the battery module; and
the base plate is provided with:
   a first suspension member (lower suspension member 81) which crosses the flow path and forms a part of the flow path (flow path 53b); and
   a second suspension member (upper suspension member 82) which extends above the first suspension member.

According to (1), since the base plate is provided with the first suspension member which crosses the flow path and forms a part of the flow path, the first suspension member functions not only as a duct but also as a reinforcing member which improves the rigidity of the base plate. Therefore, the rigidity of the base plate can be improved with a small number of components. In addition, since the base plate is provided with the second suspension member extending above the first suspension member, it is possible to further improve the rigidity of the base plate.

(2) The battery unit according to (1), in which:
one end (rear end 82a) and the other end (front end 82b) of the second suspension member are fixed to the base plate; and
the first suspension member and the second suspension member are fixed to each other between the one end and the other end.

According to (2), since the first suspension member and the second suspension member are fixed to each other between the one end and the other end, the first suspension member and the second suspension member can function as a stronger reinforcing member.

(3) The battery unit according to (1) or (2), further including:
a fan (fan 20) which is mounted on the base plate; and
an air feeding duct (air feeding duct 40) which is connected to an air blow-out port (air blow-out port 24) of the fan and communicates the air blow-out port with the flow path, in which:
the air feeding duct is open to a lower side and covers an upper surface of the first suspension member; and
a seal member (seal member 47) is provided between the upper surface of the first suspension member and a lower surface of the air feeding duct.

According to (3), since the seal member is provided between the upper surface of the first suspension member and the lower surface of the air feeding duct, the flow path can be sealed only by covering the upper surface of the first suspension member with the air feeding duct from above. Therefore, assembly of the battery unit is facilitated.

(4) The battery unit according to (3), in which
the air feeding duct is fixed to the second suspension member.

According to (4), since the air feeding duct is fixed to the second suspension member, the second suspension member can also be used for fixing the air feeding duct.

(5) The battery unit according to any one of (1) to (4), further including:
a battery module fixing member (module fixing portion 72) which supports the battery module and is fixed to the second suspension member, in which
the battery module is fixed to the base plate via the battery module fixing member and the second suspension member.

According to (5), since the battery module is fixed to the base plate via the battery module fixing member and the second suspension member, the second suspension member can support the battery module while functioning as a reinforcing member which reinforces the base plate.

(6) The battery unit according to (5), in which:
the second suspension member includes a first fixing portion (fixing portion F2) by which the battery module fixing member is fixed; and
the first suspension member is fixed by the first fixing portion together with the battery module fixing member.

According to (6), since the battery module fixing member is also fixed to the first suspension member together with the second suspension member by the first fixing portion, the rigidity of the structure for fixing the battery module can be improved as compared with a case where the battery module fixing member is fixed only to the second suspension member.

(7) The battery unit according to any one of (1) to (6), in which:
the base plate includes a vehicle fixing portion (vehicle fixing portion 51a) fixed to the vehicle; and
the second suspension member includes a second fixing portion (front end fixing portion F1) fixed to the vehicle fixing portion.

According to (7), since the second suspension member includes the second fixing portion fixed to the vehicle fixing portion, the rigidity of the vehicle fixing portion can be improved.

(8) The battery unit according to any one of (1) to (7), in which
the flow path communicates with an inter-cell flow path (inter-cell flow path 11a) formed between the battery cells.

According to (8), since the flow path communicates with the inter-cell flow path formed between the battery cells, the battery cells can be cooled.

What is claimed is:

1. A battery unit mounted on a vehicle, the battery unit comprising:
a base plate; and
a battery module which is fixed to the base plate and in which a plurality of battery cells are stacked, wherein:
a flow path is formed between the base plate and the battery module; and
the base plate is provided with:
a first suspension member which crosses the flow path and forms a part of the flow path; and
a second suspension member which extends above the first suspension member.

2. The battery unit according to claim 1, wherein:
one end and the other end of the second suspension member are fixed to the base plate; and
the first suspension member and the second suspension member are fixed to each other between the one end and the other end.

3. The battery unit according to claim 1, further comprising:
a fan which is mounted on the base plate; and
an air feeding duct which is connected to an air blow-out port of the fan and communicates the air blow-out port with the flow path, wherein:
the air feeding duct is open to a lower side and covers an upper surface of the first suspension member; and
a seal member is provided between the upper surface of the first suspension member and a lower surface of the air feeding duct.

4. The battery unit according to claim 3, wherein
the air feeding duct is fixed to the second suspension member.

5. The battery unit according to claim 1, further comprising:
a battery module fixing member which supports the battery module and is fixed to the second suspension member, wherein
the battery module is fixed to the base plate via the battery module fixing member and the second suspension member.

6. The battery unit according to claim 5, wherein:
the second suspension member includes a first fixing portion by which the battery module fixing member is fixed; and
the first suspension member is fixed by the first fixing portion together with the battery module fixing member.

7. The battery unit according to claim 1, wherein:
the base plate includes a vehicle fixing portion fixed to the vehicle; and
the second suspension member includes a second fixing portion fixed to the vehicle fixing portion.

8. The battery unit according to claim 1, wherein
the flow path communicates with an inter-cell flow path formed between the battery cells.
